(19) United States
(12) Patent Application Publication
(10) Pub. No.: US 2024/0386242 A1
(43) Pub. Date: Nov. 21, 2024

(54) SYSTEMS AND METHODS FOR SELF-SUPPERVISED TIME-SERIES REPRESENTATION LEARNING

(71) Applicant: Royal Bank of Canada, Toronto (CA)

(72) Inventors: Frederick TUNG, Toronto (CA); Leila PISHDAD, Toronto (CA); Ainaz IAJIMORADLOU, Toronto (CA); Maryna KARPUSHA, Toronto (CA)

(21) Appl. No.: 18/199,611

(22) Filed: May 19, 2023

(51) Int. Cl. G06N 3/045

(52) U.S. Cl. CPC G06N 3/045

(57) ABSTRACT

A neural network for creating representations of time-series may be trained using a self-supervised approach and as such does not require explicit labelling of the training data. The training uses similarity distillation along both the temporal and instance dimensions. Once trained, the neural network may be used to generate representations of a time-series suitable for use on various downstream tasks.

### RELATED APPLICATION

The current application claims priority to U.S. Provisional application 63/344,094 filed May 20, 2022, entitled Systems and Methods for Self-Supervised Time-Series Representation Learning, the entire contents of which is incorporated herein by reference in its entirety.

### TECHNICAL FIELD

The current disclosure relates to a learning process for generating time-series representations, and in particular to a learning process that is self-supervised.

### BACKGROUND

Large-scale pre-trained models can provide an initial foundation in many real-world machine learning systems. These pre-trained models are often used in the domains of computer vision and natural language processing. Despite the wide range of applications in healthcare, finance, transportation, energy, etc., the development of large-scale pre-trained models for time series remains under-explored in the machine learning community.

Additional, alternative and/or improved systems and method for use in the development of pre-trained models for time-series are desirable.

### SUMMARY

In accordance with the present disclosure there is provided a method of generating a neural network that provides a universal time-series representation, the method comprising: determining a temporal loss based on teacher temporal similarities between representations at different temporal locations within a teacher representation of an input time-series and student temporal similarities between representations at different temporal locations within a student representation of the input time-series; determining an instance loss based on teacher instance similarities between representations at common temporal locations within the teacher representation and a plurality of anchor representations and student instance similarities between representations at common temporal locations within the student representation and the plurality of anchor representations; updating the student encoder based on the temporal loss and instance loss; and updating the teacher encoder as a moving average of the student encoder.

In a further embodiment of the method, the method further comprises: applying a first augmented subsequence of the input time-series to a teacher encoder to generate the teacher representation of the input time-series; and applying a second augmented subsequence of the input time-series to a student encoder to generate the student representation of the input time-series.

In a further embodiment of the method, the first augmented subsequence is generated by applying a first augmentation to a first sampled subsequence of the input time series and the second augmented subsequence is generated by applying a second augmentation to a second sampled subsequence of the input time series, wherein the first and second sampled subsequences have a minimum overlap The method of claim 3, wherein the first augmentation and the second augmentation have the same number of timestamps.

In a further embodiment of the method, the method further comprises: determining the teacher temporal similarities by: comparing a representation of the teacher representation at a particular temporal location to representations of the teacher representation at other temporal locations.

In a further embodiment of the method, the method further comprises: determining the student temporal similarities by: comparing a representation of the student representation at the particular temporal location to representations of the student representation at other temporal locations.

In a further embodiment of the method, the temporal loss is determined by summing Kullback-Leibler divergences between the teacher temporal similarities and the student temporal similarities over all temporal position.

In a further embodiment of the method, the method further comprises: determining the teacher instance similarities by: comparing a representation of the teacher representation at a first temporal location to representations of a plurality of anchor sequences at the first temporal location.

In a further embodiment of the method, the method further comprises: determining the student instance similarities by: comparing a representation of the student representation at a second temporal location to representations of the plurality of anchor sequences at the second temporal location.

In a further embodiment of the method, the instance loss is determined by summing Kullback-Leibler divergences between the teacher instance similarities and the student instance similarities over all temporal position.

In a further embodiment of the method, the plurality of anchor sequences comprise previous subsequences used to generate the teacher representations or the student representation.

In accordance with the present disclosure there is further provided a neural network trained according to any one of the methods described above.

In accordance with the present disclosure there is further provided a non-transitory computer readable memory storing instructions, which when executed by a processor of a system configure the system to perform the method of any one of methods described above.

This summary does not necessarily describe the entire scope of all aspects of the systems and methods for time-series forecasting. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a system for self-supervised learning of time-series representations;

FIG. 2 depicts components of, and a process for, similarity distillation learning;

FIG. 3 depicts a process for determining a temporal similarity;

FIG. 4 depicts a process for determining an instance similarity; and

FIG. 5 depicts a method for learning a time-series representation using similarity distillation learning.

### DETAILED DESCRIPTION

A self-supervised method for pre-training universal time series representations is described. An important step for building a pre-trained model for time-series is the self-supervised learning of a universal representation for time series. The current application provides a self-supervised representation learning method for time series in which similarity distillation is used as an alternative source of self-supervision compared to traditional negative-positive contrastive pairs. As described further below, contrastive representations are learned using similarity distillation along both the temporal and instance dimensions.

Self-supervised techniques can be used for learning representations without requiring explicit labels. The pre-trained representations can afterwards be fine-tuned with fewer labelled data for different downstream tasks. For time series representation learning, pre-training approaches have shifted from simpler approaches such as using a sequence-to-sequence encoder-decoder architecture to more advanced techniques, such as using either pretext tasks such as learning the masked values or contrastive learning on different augmentations of the input series. Contrastive methods have been empirically shown to have a better performance. Previous contrastive method have been trained by augmenting every batch and taking the augmentations of the same input as a positive pair and augmentations of different inputs as negative pairs. The contrastive loss brings the representations of the elements in positive pairs closer to each other than the elements that form a negative pair.

However, contrastive methods for self-supervised representation learning rely on the assumption that the augmentation of a given sample will generate a negative pair with other samples in the batch. This assumption is not always valid: there could be samples of the same class in the current batch which would mean that not all the assumed negative samples are truly negative. To address this issue, instead of using positive and negative pairs with contrastive learning, the current approach for learning the time-series representation uses knowledge distillation based approaches, in which a student network is trained to produce the same similarity PDF as a teacher network (with momentum-updated weights) between the current elements in the batch and a set of anchors.

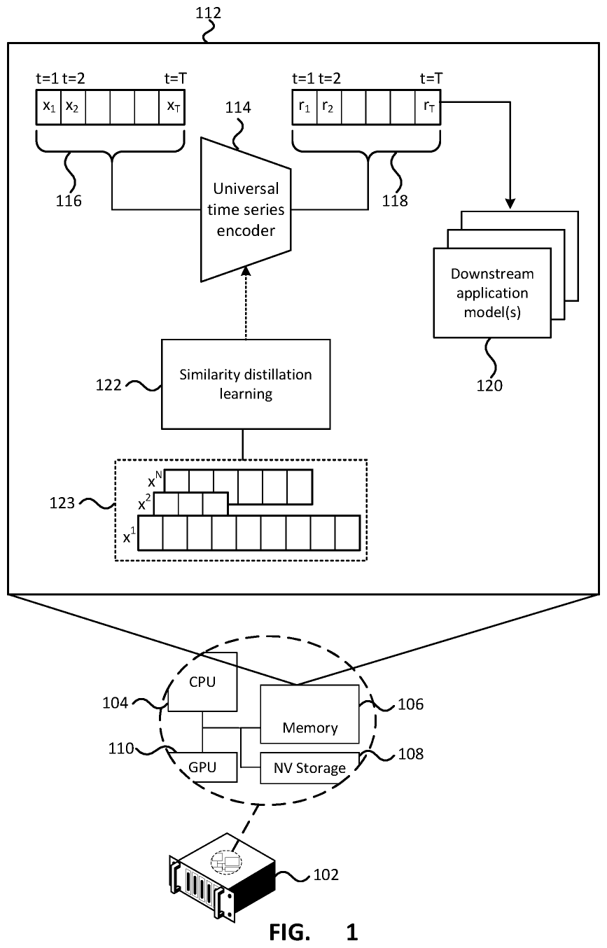

FIG. 1 depicts a system for self-supervised learning of time-series representations. The system may be provided by a computer system denoted generally by reference numeral 102. Although not depicted in FIG. 1, the computer system 102 may further include input and output devices such as a display, speakers, keyboard, mouse, etc. It will be appreciated that other types of input devices may be provided such as a touch screen.

The computer system 102 may contain one or more processors or microprocessors, such as a central processing unit (CPU) 104. The CPU 104 performs arithmetic calculations and control functions to execute software stored in a non-transitory internal memory 106, preferably random access memory (RAM) and/or read only memory (ROM), and possibly additional memory 108. The additional memory 108 is non-volatile may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 108 may be physically internal to the computer system, or both.

The one or more processors or microprocessors may comprise any suitable processing unit such as an artificial intelligence accelerator, programmable logic controller, a microcontroller (which comprises both a processing unit and a non-transitory computer readable medium), AI accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

The computer system 102 may also include other similar means for allowing computer programs or other instructions to be loaded. Such means can include, for example, a communications interface (not shown) which allows software and data to be transferred between the computer system and external systems and networks. Examples of communications interface can include a modem, a network interface such as an Ethernet card, a wireless communication interface, or a serial or parallel communications port. Software and data transferred via communications interface are in the form of signals which can be electronic, acoustic, electromagnetic, optical or other signals capable of being received by communications interface. Multiple interfaces, of course, can be provided on a single computer system.

Input and output to and from the computer system may be administered by the input/output (I/O) interface (not shown). The I/O interface may administer control of the display, keyboard, external devices and other such components of the computer system. The computer system may also include a graphical processing unit (GPU) 110. The GPU may also be used for computational purposes as an adjunct to, or instead of, the (CPU) 10, for mathematical calculations.

The various components of the computer system may be coupled to one another either directly or by coupling to suitable buses. The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The memory 106 may store instructions which when executed by the processor 104, and possibly the GPU 110, configure the system 102 to provide various functionality 112. The functionality 112 may include a universal time-series encoder 114, which given an input time series 116 having a number, T, of timestamps can map the series to a corresponding representation 118, which also has T timestamps. The representation 118 generated by the trained universal time-series encoder 114 may be used by one or more downstream applications 120. The applications may include for example tasks related to classification, anomaly detection and/or forecasting. It will be appreciated that other applications may use the representation 118. Depending upon the application, and possibly the data available, the trained universal time series encoder 114 may be further fine-tuned for the application and/or data.

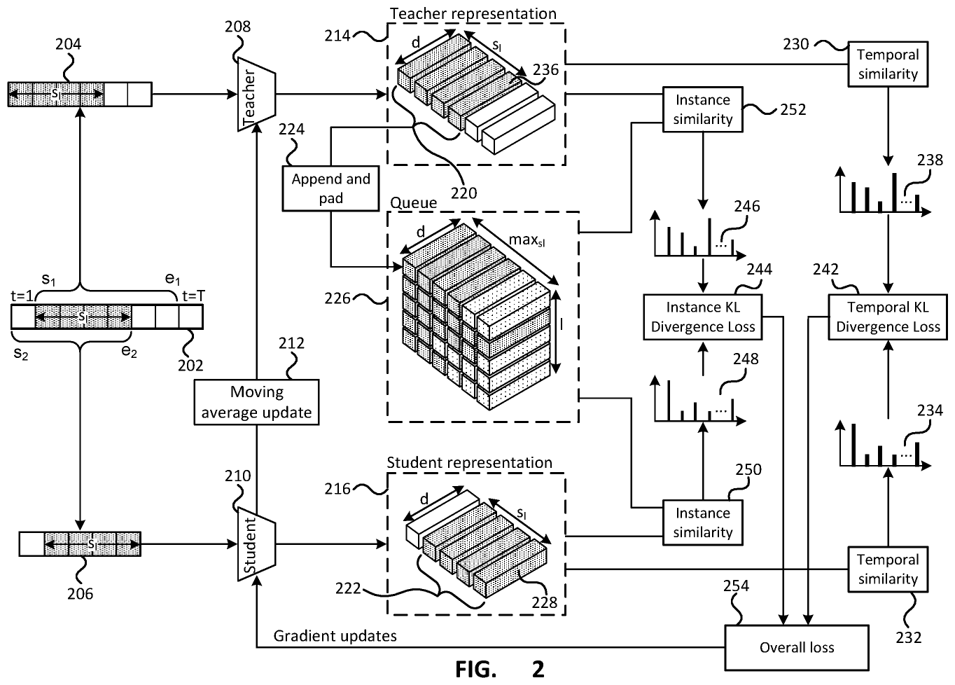

In order to generate the universal time-series encoder 114, similarity distillation learning functionality 122 may be applied to one or more time-series 124. The time-series 124 may be different time-series which may be unrelated to each other. Each of the time-series may have its own number of timestamps in the time-series. Each of the time-series may be applied by the similarity distillation learning process individually. Although depicted as being implemented on the same computer system, the universal time series encoder may be deployed on different computer systems than the computer system or systems used to train the universal time-series encoder. The similarity distillation learning process provided by the similarity distillation learning functionality 122 is described in further detail below with reference to FIG. 2.

FIG. 2 depicts components of, and a process for, similarity distillation learning. FIG. 2 provides details of the model architecture for similarity distillation learning of time-series representations.

The architecture and process of FIG. 2 learns a non-linear embedding function for a set of time series [symbol] ={x¹, x², . . . , x^{N}} of size N that maps each time series xⁱ with Tᵢtimestamps, to its best describing representation rⁱ={r₁ⁱ, r₂ⁱ, . . . , r_{T}_{ᵢ}ⁱ}. Each rⱼⁱ ∈ [symbol] ^{d} is the representation of time series xⁱ at timestamp j.

The process uses a student-teacher framework that uses similarity distillation to learn time series representations in a self-supervised manner. A similar augmentation technique to that of the TS2Vec method is applied to an input time-series 202, which samples the input sequence to provide two overlapping subsequences 204, 206 from the input sequence 202. The two overlapping subsequences 204, 206 can be sampled by randomly drawing two pairs of start (s1, s2) and end indices (e1, e2). The pairs of start and end indices may be checked to ensure that there is a minimum overlap between the two sampled subsequences, such as sₗ which may be an integer great than 1. If there is not a minimum overlap, different start and end pairs may be drawn. Additionally, the length of the sampled subsequences 204, 206 may be the same or different and may have a maximum length, such as maxₛₗ which may be an integer greater than 1.

The two subsequence 204, 206 may be applied to respective encoders, namely a teacher encoder 208 and a student encoder 210. The teacher and student encoders 208, 210 may have the same structure, but with different weightings. The weightings of the teacher encoder 208 may be updated using a moving average 212 of the student encoder 210 weightings, which are updated as described in further detail below.

The teacher encoder 208 is applied to the teacher subsequence 204 to generate a teacher representation 214 of the teacher subsequence. Similarly, the student encoder 210 is applied to the student subsequence 206 to generate a student representation 216 of the student subsequence 206. Each of the teacher and student representations 214, 216 comprise a corresponding number of timestamps with each having d features. Each of the student and teacher encoders may have a similar architecture as the teacher/student encoders of TS2Vec. Each encoder may comprise three components: an input projection layer, a timestamp masking module, and a dilated CNN module. Gradients of the network are only propagated through the student encoder while the teacher encoder is the moving average of the student encoder to avoid collapse.

Applying each of the teacher and student subsequences 204, 206 to the teacher and student encoders 208, 210 results in a matrix for the teacher representation 214 and the student representation 216. The dimensions of each matrix may be l×d where l is the length of the input sequence. The overlapping portion between the teacher and student subsequences are depicted as blocks 220 and 222. The dimensions of the overlapping portions is sₗ×d where sₗ is the sequence length of the overlapping portion of the two sampled subsequences 204, 206 and d is the dimension of each temporal representation. It is noted that the length of the teacher representation 214 and student representation 216 may be longer than the overlapping matrix 220 and 222, as depicted by the respective white blocks, however the representations of the non-overlapping portions may be ignored or omitted in the further processing.

The overlapping matrix portion 220 of the teacher representation 214 may be stored or appended 224 to a queue 226 of anchor sequences. The length of overlapping portions of different sampled subsequences may vary between a minimum, minₛₗ, and a maximum, maxₛₗ. If the length of the overlapping matrix 220 is less than the maximum, maxₛₗ the matrix representation being stored in the queue 226 may be padded with blank or empty representations in the padded temporal representations, depicted by light grey blocks of queue 226. The queue may be stored in a memory buffer and provides a three dimensional matrix of the anchor representations of size maxₛₗ×sₗ×d where l is the length of the buffer.

To learn an effective representation for time series, the goal is to capture the relationship between the events at various timestamps within the same sequence, which may be considered as the temporal objective, as well as to capture the relationship across different sequences, which may be considered as the instance objective.

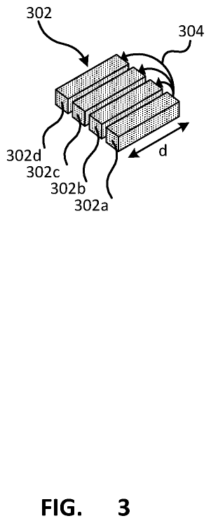

Let sⱼ denote the student representation of an augmented sequence at temporal position j, illustrated as a single d-dimensional slice 228. The temporal loss is computed as follows. First, sⱼ is contrasted with the other student representations of the same augmented sequence at all other temporal positions. This is depicted in FIG. 3. The comparison between two representations may be done using a similarity function.

FIG. 3 depicts a process for determining a temporal similarity. The temporal similarity of FIG. 3 is depicted for an overlapping matrix 302 representation. Although the representation 302 is depicted as the same dimensions as the overlapping student matrix 222, the same process may be used for, the teacher overlapping matrix 220. As depicted, a d-dimensional slice 302a is contrasted with each of the other temporal representations 302b, 302c, 302d as depicted by arrows 304. The temporal similarity process depicted in FIG. 3 may be used for the teacher temporal similarity 230 and the student temporal similarity 232 of FIG. 2.

Given a similarity function sim, such as cosine similarity, it is possible to obtain student temporal similarity 234 between two d-dimensional slices as the sₗ-dimensional probability distribution described by:

$${p}_{s , j}^{temp} ( k ) = \frac{exp ( sim ( {s}_{j} , {s}_{k} ) / τ )}{{\sum }_{m = 1}^{{s}_{l}} exp ( sim ( {s}_{j} , {s}_{m} ) / τ )} , \qquad ( 1 )$$

In equation (1) τ is a temperature hyperparameter. The teacher temporal similarlity can be determined in the same manner as equation (1) but with tⱼ denoting the teacher representation of the augmented sequence at temporal position j instead of sⱼ for the student temporal similarity. tⱼ may be illustrated as a single d-dimensional slice such as slice 236. The teacher temporal similarity 238 may be computed as:

$${p}_{t , j}^{temp} ( k ) = \frac{exp ( sim ( {t}_{j} , {t}_{k} ) / τ )}{{\sum }_{m = 1}^{{s}_{l}} exp ( sim ( {t}_{j} , {t}_{m} ) / τ )} . \qquad ( 2 )$$

The temporal loss 242, [symbol] ^{temp}, may be obtained by summing the KL (Kullback-Leibler) divergences of equations (1) and (2), KL(P_{t,j}^{temp}, p_{s,j}^{temp}) over all temporal positions:

$${ℒ}^{temp} = {\sum }_{j = 1}^{{s}_{l}} KL ( {p}_{t , j}^{temp} ‖ {p}_{s , j}^{temp} ) . \qquad ( 3 )$$

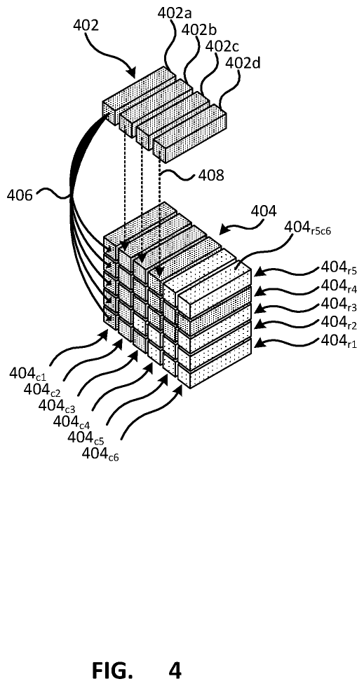

In addition to the temporal loss 242 between the student/teacher temporal similarities 234, 238, the instance loss is 244 is determined from the teacher instance similarities 246 and the student instance similarities 248. The student instance similarity process 250 contrasts a respective representation sⱼ with the representations of buffered sequences in the queue 226 at corresponding temporal positions j. A similar process is done for the teacher instance process 252. The comparissons for the instance similarity process is depicted in FIG. 4.

FIG. 4 depicts a process for contrasting the instance similarity. The process compares an overlapping matrix 402 to representations stored in the queue 404. The overlapping matrix 402 comprises a plurality, sₗ, of d-dimensional representations 402a, 402b, 402c, 402d. The queue comprises a number of rows 404_{r1 . . . 5} and columns 40_{4c1 . . . 6} of d-dimensional representations, one of which is depicted as 404_{r5c6}, namely the temporal representation of the 5^{th} row and 6^{th} column. Each temporal representation 402_{a . . . d} is contrasted with each representation at the corresponding temporal location in the queue 404. Each contrasting of the temporal representations of the queue and the first temporal representation 402a is depicted by arrows 406 in FIG. 4. The comparisson of the different temporal representation 402b . . . d is depicted by dotted arrows 408 but does not depict each comparisson as depicted by arrows 406.

Returning to FIG. 2, the l-dimensional student isntance probability distribution 248 may be determined according to:

$${p}_{s , j}^{inst} ( k ) = \frac{exp ( sim ( {s}_{j} , {q}_{j}^{k} ) / τ )}{{\sum }_{m = 1}^{l} exp ( sim ( {s}_{j} , {q}_{j}^{m} ) / τ )} , \qquad ( 4 )$$

Similarly the teacher instance probability distribution 246 may be determined according to:

$${p}_{t , j}^{inst} ( k ) = \frac{exp ( sim ( {t}_{j} , {q}_{j}^{k} ) / τ )}{{\sum }_{m = 1}^{l} exp ( sim ( {t}_{j} , {q}_{j}^{m} ) / τ )} , \qquad ( 5 )$$

In equation (5), q^{k} denotes the kth anchor sequence in the queue 226. The instance loss 244 may then obtained by summing the KL divergences KL (pₜ^{inst}||pₛ^{inst}) over all temporal positions:

$${ℒ}^{inst} = {\sum }_{j = 1}^{{s}_{l}} KL ( {p}_{t , j}^{inst} ‖ {p}_{s , j}^{inst} ) . \qquad ( 6 )$$

The overall self-supervised loss 254 is based on the temporal loss and the instance loss and may be given by:

$$ℒ = α \cdot {ℒ}^{inst} + ( 1 - α ) \cdot {ℒ}^{temp} , \qquad ( 7 )$$

In equation (7) α is a balancing hyperparameter.

The overall loss function 254 is used to update the student encoder 210, and the learning process may continue with an additional subsequence from the same time-series, or training may continue with a different time-series. The teacher encoder 208 may be updated, for example, as a moving average of the student encoder.

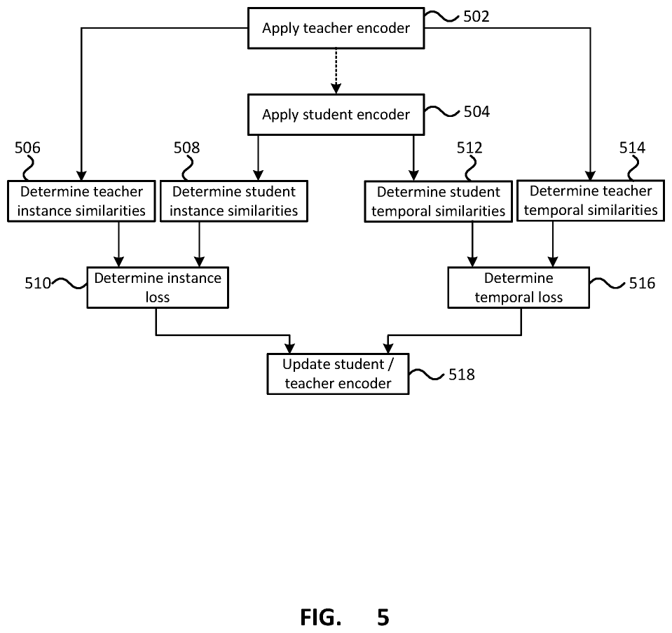

FIG. 5 depicts a method for learning a time-series representation using similarity distillation learning. The method depicted in FIG. 5 applies a teacher encoder to a first augmented subsequence (502). A student encoder is applies to a second augmented subsequence (504). The augmented sequences are selected such that they will have neighbors in the teacher and student encoding spaces. Although not depicted in FIG. 5, two overlapping subsequences from an input time-series may be randomly sampled and applied used to generate the respective first and second augmented subsequences. The teacher and student representations resulting from applying the teacher and student encoders respectively, are used to determine instance similarities of the representations within the same temporal position. The temporal positions of the representations are compared to the same temporal positions of representations of a plurality of anchor sequences. The teacher instance similarities are determined (506) along with the student instance similarities (508). The teacher and student instance similarities are used to determine an instance loss (510). In addition to determining the instance similarities, the student temporal similarities are determined (512) along with the teacher temporal similarities (514). The temporal similarities are then used to determine a temporal loss. The combined temporal loss and instance loss may be used to update the student encoder (518) which in turn is used to update the teacher encoder. The teacher encoder may be updated as a moving average of the student encoder. The method depicted in FIG. 5 may be repeated for a number of subsequences from the same time-series as well as for different time-series.

A model trained using the process described above was used to evaluate the resulting representations on various downstream tasks. The model was evaluated on three different downstream tasks, namely classification, anomaly detection, and forecasting. For the classification task the 125 UCR and 30 UEA benchmarks were used, which consist of many small datasets of univariate time series. To evaluate the performance of the model, accuracy was used. For the anomaly detection task, the KPI dataset (Ren et al., 2019) was used. The KPI dataset is a competition dataset released by the AIOPS Challenge. It consists of multiple KPI (key performance indicator) curves from 58 companies with very long sequences varying from 4,000 to 75,000 for the anomaly detection task. Precision, recall, and F1 score were used to evaluate the performance of the model. For the forecasting task, the 3ETT dataset (Zhou et al., 2021) and the Electricity dataset (Dua & Graff, 2017) were used. Both univariate and multivariate forecasting were performed and the performance evaluated by calculating the mean-squared-error (MSE) and mean-absolute-error (MAE).

The size of the queue was 128 in all experiments, the temperature τ was 0.07, and the temporal and instance losses were the same weight in optimization, i.e., α=0.5. For all hyperparameters in common with TS2Vec, such as the learning rate the hyperparameter settings reported in Yue et al., 2022 were used. The same pre-trained representations were used for all three downstream tasks without further fine-tuning.

Table 1 shows the overall performance of the current full model on the UCR and UEA datasets for classification. The current model achieves competitive performance: it outperforms several recent self-supervised techniques, including TST (Zerveas et al., 2021)), TS-TCC (Eldele et al., 2021), and TNC (Tonekaboni et al., 2021) on both UCR and UEA; however, TS2Vec outperforms the current model on this task. The results show that adding the hierarchical contrast does not improve the current model for classification.

TABLE 1

| Model | Dataset | Acc. |
|---|---|---|
| TST | UCR | 64.1 |
| TS-TCC | UCR | 75.7 |
| TNC | UCR | 76.1 |
| T-Loss | UCR | 80.6 |
| TS2Vec | UCR | 82.0 |
| Current | UCR | 79.1 ± 0.2 |
| TST | UEA | 63.5 |
| TS-TCC | UEA | 67.5 |
| TNC | UEA | 67.7 |
| T-Loss | UEA | 68.2 |
| TS2Vec | UEA | 71.2 |
| Current | UEA | 68.6 ± 0.6 |

Table 2 shows experimental results on the KPI dataset for anomaly detection. On this task, the current model achieves higher recall and F1 scores, while TS2Vec performs better on precision.

TABLE 2

| Model | Precision ↑ | Recall ↑ | F1 ↑ |
|---|---|---|---|
| TS2Vec | 92.9 | 53.3 | 67.7 |
| Current | 91.6 ± 0.4 | 54.8 ± 1.2 | 68.6 ± 0.8 |

Table 3 shows experimental results on the 3ETT and Electricity datasets for univariate and multivariate time series forecasting. Results are provided from Informer as well as TS2Vec. It is noted that Informer is a supervised method. In univariate forecasting, the current model achieves comparable performance to TS2Vec on ETTh1, ETTh2, and Electricity (within a standard deviation), and slightly better performance on ETTm1. In multivariate forecasting, the current model achieves comparable performance to TS2Vec on ETTh1 and ETTm1, performs worse on ETTh2, and performs better on Electricity.

TABLE 3
Univariate time series forecasting

| Model | Dataset | avg. MSE | avg. MAE |
|---|---|---|---|
| Informer | ETTh1 | 0.186 | 0.347 |
| TS2Vec | ETTh1 | 0.11 | 0.252 |
| Current | ETTh1 | 0.115 ± 0.011 | 0.258 ± 0.014 |
| Informer | ETTh2 | 0.204 | 0.358 |
| TS2Vec | ETTh2 | 0.170 | 0.321 |
| Current | ETTh2 | 0.173 ± 0.004 | 0.325 ± 0.003 |
| Informer | ETTm1 | 0.241 | 0.382 |
| TS2Vec | ETTm1 | 0.069 | 0.186 |
| Current | ETTm1 | 0.063 ± 0.003 | 0.179 ± 0.005 |
| TS2Vec | Electricity | 0.486 | 0.425 |
| Current | Electricity | 0.484 ± 0.004 | 0.419 ± 0.003 |

Multivariate time series forecasting

| Model | Dataset | avg. MSE 4. | avg. MAE 4. |
|---|---|---|---|
| Informer | ETTh1 | 0.907 | 0.739 |
| TS2Vec | ETTh1 | 0.788 | 0.646 |
| Current | ETTh1 | 0.789 ± 0.017 | 0.655 ± 0.009 |
| Informer | ETTh2 | 2.371 | 1.199 |
| TS2Vec | ETTh2 | 1.567 | 0.937 |
| Current | ETTh2 | 1.854 ± 0.140 | 1.034 ± 0.032 |
| Informer | ETTm1 | 0.749 | 0.640 |
| TS2Vec | ETTm1 | 0.628 | 0.552 |
| Current | ETTm1 | 0.618 ± 0.021 | 0.556 ± 0.013 |
| TS2Vec | Electricity | 0.330 | 0.405 |
| Current | Electricity | 0.311 ± 0.007 | 0.393 ± 0.006 |

In addition to the above experiments, the impact of similarity distillation in temporal and instance dimensions was analyzed. Table 4 presents an ablation study of the approach on all downstream tasks, showing the performance of the temporal loss, instance loss, and the full model with both losses. Ablations are also provided on the hierarchical loss as proposed in TS2Vec. On the classification and anomaly detection tasks, it was found that the temporal and instance losses are both important, with the full model obtaining the best results. On the forecasting task, the combined loss does not appear improve results. Hierarchical contrast boosts the performance on the anomaly detection and forecasting tasks by a small margin.

TABLE 4
Task: Classification

| Model | Dataset | Acc.↑ | AUPRC↑ |
|---|---|---|---|
| Instance only | UCR | 77.7 | 78.4 |
| Temporal only | UCR | 78.4 | 79.4 |
| Full model | UCR | 78.8 | 79.7 |
| Full + Hierarchical | UCR | 77.8 | 79.0 |
| Instance only | UEA | 66.8 | 68.6 |
| Temporal only | UEA | 70.0 | 69.9 |
| Full model | UEA | 69.6 | 70.4 |
| Inst. + Hierarchical | UEA | 67.7 | 69.8 |

Task: Anomaly Detection

| Model | Precision↑ | Recall↑ | F1↑ |
|---|---|---|---|
| Instance only | 91.8 | 48.0 | 63.0 |
| Temporal only | 91.8 | 54.5 | 68.4 |
| Full model | 91.8 | 55.2 | 68.9 |
| Full + Hierarchical | 92.7 | 55.3 | 68.3 |

Task: Forecasting

| Model | Type | MSE↓ | MAE↓ |
|---|---|---|---|
| Instance only | uni | 0.211 | 0.301 |
| Temporal only | uni | 0.206 | 0.292 |
| Full model | uni | 0.206 | 0.292 |
| Full + Hierarchical | uni | 0.205 | 0.293 |
| Instance only | multi | 0.846 | 0.646 |
| Temporal only | multi | 0.903 | 0.665 |
| Full model | multi | 0.914 | 0.667 |
| Inst. + Hierarchical | multi | 0.837 | 0.639 |

Sensitivity analyses were performed on temperature and queue size to evaluate their impact on different tasks. Table 5 shows a set of different temperatures for both student (s_{τ}) and teacher (t₉₆ ) networks on the anomaly detection task. Using different temperatures for student and teacher networks can improve the final performance for anomaly detection. However, using the best temperature on anomaly detection does not improve the results on other tasks. In Table 5 the bottom rows for each task show the original setting used in the model. The best temperatures from the anomaly detection task are used on other downstream tasks to evaluate performance.

TABLE 5
Task: Anomaly Detection

| s_{τ} | t_{τ} | Precision ↑ | Recall ↑ | F1↑ |
|---|---|---|---|---|
| 0.1 | 0.01 | 92.1 | 53.6 | 67.7 |
| 0.4 | 0.04 | 89.7 | 57.2 | 69.9 |
| 0.7 | 0.07 | 90.7 | 59.1 | 71.6 |
| 0.01 | 0.01 | 92.2 | 55.1 | 68.9 |
| 0.05 | 0.05 | 91.9 | 54.7 | 68.6 |
| 0.1 | 0.1 | 91.7 | 56.5 | 69.9 |
| 0.2 | 0.2 | 92.3 | 55.7 | 69.5 |
| 0.07 | 0.07 | 91.8 | 55.2 | 68.9 |

Task: Classification

| s_{τ} | t_{τ} | Dataset | Accuracy ↑ | AUPRC↑ |
|---|---|---|---|---|
| 0.7 | 0.07 | UCR | 77.5 | 78.2 |
| 0.7 | 0.07 | UEA | 68.3 | 69.8 |
| 0.07 | 0.07 | UCR | 78.8 | 79.7 |
| 0.07 | 0.07 | UEA | 69.6 | 70.4 |

Task: Forecasting

| s_{τ} | t_{τ} | Type | avg. MSE ↓ | avg. MAE ↓ |
|---|---|---|---|---|
| 0.7 | 0.07 | uni | 0.216 | 0.299 |
| 0.7 | 0.07 | multi | 0.952 | 0.683 |
| 0.07 | 0.07 | uni | 0.206 | 0.292 |
| 0.07 | 0.07 | multi | 0.914 | 0.667 |

The impact of queue size on a subset of datasets was also analyzed. Table 6 shows that increasing queue size can help with classification and anomaly detection while there appears to be a sweet spot. On the other hand, queue size does not appear have a significant impact on forecasting. Modestly better results were obtained when using a smaller queue size for forecasting.

TABLE 6
Task: Classification on UCR.

| Queue | Accuracy ↑ | AUPRC |
|---|---|---|
| 64 | 78.6 | 79.9 |
| 128 | 78.8 | 79.7 |
| 256 | 79.1 | 80.1 |
| 512 | 78.9 | 79.6 |

Task: Anomaly Detection.

| Queue | Precision ↑ | Recall ↑ | F1 ↑ |
|---|---|---|---|
| 64 | 91.9 | 54.8 | 68.6 |
| 128 | 91.8 | 55.2 | 68.9 |
| 256 | 91.9 | 56.0 | 69.6 |
| 512 | 91.7 | 55.3 | 69.0 |

Task: Univariate Forecasting on ETTh1.

| Queue | H | MSE ↓ | MAE ↓ |
|---|---|---|---|
| 64 | 24 | 0.045 | 0.164 |
| 128 | 24 | 0.045 | 0.163 |
| 256 | 24 | 0.046 | 0.165 |
| 64 | 48 | 0.068 | 0.201 |
| 128 | 48 | 0.068 | 0.202 |
| 256 | 48 | 0.069 | 0.203 |
| 64 | 168 | 0.115 | 0.260 |
| 128 | 168 | 0.116 | 0.262 |
| 256 | 168 | 0.117 | 0.263 |
| 64 | 336 | 0.131 | 0.280 |
| 128 | 336 | 0.132 | 0.282 |
| 256 | 336 | 0.132 | 0.282 |
| 64 | 720 | 0.161 | 0.323 |
| 128 | 720 | 0.163 | 0.325 |
| 256 | 720 | 0.163 | 0.325 |

Table 7 and Table 8 show detailed forecasting results on different horizons. Table 7 shows univariate forecasting per horizon and dataset and Table 8 shows multivariate forecasting per horizon and dataset.

TABLE 7

| | | C | | TS2Vec | | Informer | |
|---|---|---|---|---|---|---|---|
| Dataset | H | MSE | MAE | MSE | MAE | MSE | MAE |
| ETTm1 | 24 | 0.015 ± 0.001 | 0.093 ± 0.004 | 0.015 | 0.092 | 0.030 | 0.137 |
| ETTm1 | 48 | 0.028 ± 0.002 | 0.125 ± 0.005 | 0.027 | 0.126 | 0.069 | 0.203 |
| ETTm1 | 96 | 0.042 ± 0.002 | 0.156 ± 0.004 | 0.044 | 0.161 | 0.194 | 0.372 |
| ETTm1 | 288 | 0.093 ± 0.005 | 0.232 ± 0.006 | 0.103 | 0.246 | 0.401 | 0.554 |
| ETTm1 | 672 | 0.138 ± 0.008 | 0.286 ± 0.009 | 0.156 | 0.307 | 0.512 | 0.644 |
| ETTh1 | 24 | 0.042 ± 0.002 | 0.158 ± 0.005 | 0.039 | 0.152 | 0.098 | 0.247 |
| ETTh1 | 48 | 0.065 ± 0.003 | 0.197 ± 0.006 | 0.062 | 0.191 | 0.158 | 0.319 |
| ETTh1 | 168 | 0.138 ± 0.018 | 0.287 ± 0.022 | 0.134 | 0.282 | 0.183 | 0.346 |
| ETTh1 | 336 | 0.156 ± 0.020 | 0.310 ± 0.024 | 0.154 | 0.310 | 0.222 | 0.387 |
| ETTh1 | 720 | 0.174 ± 0.014 | 0.338 ± 0.020 | 0.163 | 0.327 | 0.269 | 0.435 |
| ETTh2 | 24 | 0.092 ± 0.002 | 0.232 ± 0.002 | 0.090 | 0.229 | 0.093 | 0.240 |
| ETTh2 | 48 | 0.128 ± 0.001 | 0.277 ± 0.001 | 0.124 | 0.273 | 0.155 | 0.314 |
| ETTh2 | 168 | 0.205 ± 0.010 | 0.359 ± 0.008 | 0.208 | 0.360 | 0.232 | 0.389 |
| ETTh2 | 336 | 0.216 ± 0.007 | 0.373 ± 0.004 | 0.213 | 0.369 | 0.263 | 0.417 |
| ETTh2 | 720 | 0.224 ± 0.005 | 0.384 ± 0.005 | 0.214 | 0.374 | 0.277 | 0.431 |
| Electricity | 24 | 0.259 ± 0.003 | 0.280 ± 0.002 | 0.260 | 0.288 | — | — |
| Electricity | 48 | 0.309 ± 0.002 | 0.315 ± 0.005 | 0.319 | 0.324 | 0.239 | 0.359 |
| Electricity | 168 | 0.426 ± 0.008 | 0.388 ± 0.004 | 0.427 | 0.394 | 0.447 | 0.503 |
| Electricity | 336 | 0.560 ± 0.015 | 0.472 ± 0.004 | 0.565 | 0.474 | 0.489 | 0.528 |
| Electricity | 720 | 0.865 ± 0.006 | 0.643 ± 0.004 | 0.861 | 0.643 | 0.540 | 0.571 |

TABLE 8

| | | Current | | TS2Vec | | Informer | |
|---|---|---|---|---|---|---|---|
| Dataset | H | MSE | MAE | MSE | MAE | MSE | MAE |
| ETTm1 | 24 | 0.440 ± 0.019 | 0.444 ± 0.012 | 0.443 | 0.436 | 0.323 | 0.369 |
| ETTm1 | 48 | 0.573 ± 0.024 | 0.523 ± 0.014 | 0.582 | 0.515 | 0.494 | 0.503 |
| ETTm1 | 96 | 0.602 ± 0.020 | 0.547 ± 0.013 | 0.622 | 0.549 | 0.678 | 0.614 |
| ETTm1 | 288 | 0.684 ± 0.022 | 0.600 ± 0.013 | 0.709 | 0.609 | 1.056 | 0.786 |
| ETTm1 | 672 | 0.790 ± 0.024 | 0.664 ± 0.012 | 0.786 | 0.655 | 1.192 | 0.926 |
| ETTh1 | 24 | 0.569 ± 0.017 | 0.529 ± 0.013 | 0.599 | 0.534 | 0.577 | 0.549 |
| ETTh1 | 48 | 0.607 ± 0.016 | 0.556 ± 0.012 | 0.629 | 0.555 | 0.685 | 0.625 |
| ETTh1 | 168 | 0.759 ± 0.014 | 0.646 ± 0.009 | 0.755 | 0.636 | 0.931 | 0.752 |
| ETTh1 | 336 | 0.920 ± 0.025 | 0.729 ± 0.011 | 0.907 | 0.717 | 1.128 | 0.873 |
| ETTh1 | 720 | 1.092 ± 0.024 | 0.815 ± 0.009 | 1.048 | 0.790 | 1.215 | 0.896 |
| ETTh2 | 24 | 0.523 ± 0.068 | 0.554 ± 0.042 | 0.398 | 0.461 | 0.720 | 0.665 |
| ETTh2 | 48 | 1.058 ± 0.630 | 0.681 ± 0.051 | 0.580 | 0.573 | 1.457 | 1.001 |
| ETTh2 | 168 | 2.293 ± 0.120 | 1.187 ± 0.042 | 1.901 | 1.065 | 3.489 | 1.515 |
| ETTh2 | 336 | 2.573 ± 0.105 | 1.305 ± 0.045 | 2.304 | 1.215 | 2.723 | 1.340 |
| ETTh2 | 720 | 2.823 ± 0.215 | 1.439 ± 0.064 | 2.650 | 1.373 | 3.467 | 1.473 |
| Electricity | 24 | 0.266 ± 0.008 | 0.359 ± 0.007 | 0.287 | 0.374 | — | — |
| Electricity | 48 | 0.286 ± 0.008 | 0.375 ± 0.007 | 0.307 | 0.388 | 0.344 | 0.393 |
| Electricity | 168 | 0.315 ± 0.007 | 0.396 ± 0.006 | 0.332 | 0.407 | 0.368 | 0.424 |
| Electricity | 336 | 0.332 ± 0.007 | 0.409 ± 0.005 | 0.349 | 0.420 | 0.381 | 0.431 |
| Electricity | 720 | 0.359 ± 0.006 | 0.428 ± 0.005 | 0.375 | 0.438 | 0.406 | 0.443 |

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A method of generating a neural network that provides a universal time-series representation, the method comprising:
determining a temporal loss based on teacher temporal similarities between representations at different temporal locations within a teacher representation of an input time-series and student temporal similarities between representations at different temporal locations within a student representation of the input time-series;
determining an instance loss based on teacher instance similarities between representations at common temporal locations within the teacher representation and a plurality of anchor representations and student instance similarities between representations at common temporal locations within the student representation and the plurality of anchor representations;
updating the student encoder based on the temporal loss and instance loss; and
updating the teacher encoder as a moving average of the student encoder.

2. The method of claim 1, further comprising:
applying a first augmented subsequence of the input time-series to a teacher encoder to generate the teacher representation of the input time-series; and
applying a second augmented subsequence of the input time-series to a student encoder to generate the student representation of the input time-series.

3. The method of claim 2, wherein the first augmented subsequence is generated by applying a first augmentation to a first sampled subsequence of the input time series and the second augmented subsequence is generated by applying a second augmentation to a second sampled subsequence of the input time series, wherein the first and second sampled subsequences have a minimum overlap.

4. The method of claim 3, wherein the first augmentation and the second augmentation have the same number of timestamps.

5. The method of claim 2, further comprising determining the teacher temporal similarities by:
comparing a representation of the teacher representation at a particular temporal location to representations of the teacher representation at other temporal locations.

6. The method of claim 5, further comprising determining the student temporal similarities by:
comparing a representation of the student representation at the particular temporal location to representations of the student representation at other temporal locations.

7. The method of claim 6, wherein the temporal loss is determined by summing Kullback-Leibler divergences between the teacher temporal similarities and the student temporal similarities over all temporal position.

8. The method of claim 2, further comprising determining the teacher instance similarities by:
comparing a representation of the teacher representation at a first temporal location to representations of a plurality of anchor sequences at the first temporal location.

9. The method of claim 8, further comprising determining the student instance similarities by:
comparing a representation of the student representation at a second temporal location to representations of the plurality of anchor sequences at the second temporal location.

10. The method of claim 9, wherein the instance loss is determined by summing Kullback-Leibler divergences between the teacher instance similarities and the student instance similarities over all temporal position.

11. The method of claim 10, wherein the plurality of anchor sequences comprise previous subsequences used to generate the teacher representations or the student representation.

12. A neural network trained according to the method of claim 1.

13. A non-transitory computer readable memory storing instructions, which when executed by a processor of a system configure the system to perform the method of claim 1.
